(19) United States
(12) Patent Application Publication
(10) Pub. No.: US 2014/0101601 A1
(43) Pub. Date: Apr. 10, 2014

(54) In-Situ Exploration and Management of Location-based Content on a Map

(71) Applicant: Steven Shu Hsiang Tang, San Jose, CA (US)

(72) Inventor: Steven Shu Hsiang Tang, San Jose, CA (US)

(21) Appl. No.: 13/647,396

(22) Filed: Oct. 9, 2012

(51) Int. Cl. G06F 3/0481

(52) U.S. Cl. CPC G06F 3/0481
USPC 715/781

(57) ABSTRACT

Traditional map-based user interfaces generate disruptive and frustrating user experiences during location-based content exploration because once a user clicks on a preview info window overlaying the map to view its full content, the user is navigated away from the map into a new window disruptively. If the user wishes to go back to the map to explore the vicinity of the preview info window, another context switch involving window closing and navigating the user interface back to the map needs to occur. The present invention defines software methods for map-based user interfaces to provide end-to-end in-situ exploration and management of location-based content. Specifically, the present invention defines methods that enable both the preview and the full location-based content to be continuously explored, edited, and administered all within the map-based context to generate much more fluid, compact, and integrated user experiences for location-based content viewers, designers, and administrators.

### CROSS-REFERENCE TO RELATED APPLICATIONS

The present invention claims priority from U.S. Provisional Patent Application No. 61/545,169 filed on Oct. 9, 2011 entitled “In-Situ Exploration of Point-Of-Interest Content for Map-Based User Interface” which is expressly incorporated in its entirety herein.

### REFERENCES CITED

U.S. Pat. No. 7,779,360, Aug. 17, 2010, Matthew Jones et al, MAP user interface US20090027418 A1, Jul. 24, 2007, Nimit H. Maru et al, Map-based interfaces for storing and locating information about geographical

U.S. Pat. No. 6,883,146, Apr. 19, 2005, Prasad V. Prabhu et al, Picture database graphical user interface utilizing map-based metaphors for efficient browsing and retrieving of pictures

U.S. Pat. No. 5,790,121, Aug. 4, 1998, Peter Sklar et al, Clustering user interface

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### FIELD OF THE INVENTION

The present invention relates generally to methods for map-based user interfaces, and more particularly, to the exploration, browsing, editing, and administration of map-based content shown by map-based user interfaces.

### BACKGROUND OF THE INVENTION

For the purposes of this document, the term “in-situ” is used herein to mean “at the same position and context”. The term “in-situ preview content-browsing window” is used herein to mean “popup info-window” for map-based user interfaces. The word “exemplary” is used herein to mean serving as an example, instance, or illustration. Any aspect or design described herein as “exemplary” is not necessarily to be construed as preferred or advantageous over other aspects or designs. The terms “user interface” and “web page” are deemed synonymous.

Map markers are small and expressive icons anchored to specific locations on the map surface and map-based user interfaces use them as hyperlinks for linking location-based content on the map surface. When a user clicks on a particular map marker, a small in-situ info window herein referred to as the in-situ preview content-browsing window, showing a preview version of the location-based content associated with anchored position of the map marker opens inside the map-based user interface. In particular, the in-situ preview content-browsing window opens and overlays on the map surface near the clicked map marker. The preview content-browsing window is in-situ because the opening of the preview content-browsing window occurs at the same position as the clicked map marker and does not change the user's perceived map-based context.

In order to let the user explore further detail related to the location-based content, at least one hyperlink is usually embedded in the preview version of the location-based content shown inside the in-situ preview content-browsing window. When a user clicks on such a hyperlink the user is navigated away from the map-based context and into a new window displaying the full version of the location-based content.

While the above usage scenario is typical, the user experience it generates is far from optimal. In particular, when a user clicks on a hyperlink in the in-situ preview content-browsing window and the full-view content opens in a new window, the user's perceived context is switched from one being map-based to one unrelated to the map. If a user wishes to go back to the map to explore the vicinity of the clicked map marker, another context switch involving the user closing the new window and navigating the user interface back to the original map needs to occur. Since a context-switch not only carries a computational penalty but a perceptual burden as well, map-based user interfaces that trigger frequent context switches during a user's location-based content exploration often generate frustrating and disorienting user experiences.

The present invention defines methods that enable map-based user interfaces to provide end-to-end in-situ exploration and management of location-based content. Specifically, when a user wishes to explore the full location-based content via clicking or some other gestures on the in-situ preview content-browsing window, the in-situ preview content-browsing window itself expands into an in-situ full-view content-browsing window overlaying the map surface to display the full location-based content without leaving the map context. In particular, the expansion of an in-situ preview content-browsing window into an in-situ full-view content-browsing window involves transition effects to aid the visual continuity and to reinforce the user's perceived map-based context being preserved during the visual transformation between the in-situ preview and full-view content-browsing windows. Furthermore, the in-situ expanded full-view content-browsing window is sized such that it leaves gaps on its four sides relative to the map-based user interface window such that the background map still shows through the gaps.

These gaps on the sides of the in-situ full-view content-browsing window are important as they further reinforce the user's perception that the in-situ full-view content-browsing window simply overlays the map surface and as such the map-based context is being retained during the full location-based content exploration. These gaps on the sides of the in-situ full-view content-browsing window are also important because they provide a way for the user to interact with the map background even with the in-situ full-view content-browsing window displayed on top of the map surface.

When a user clicks on the background map surface, the in-situ full-view content-browsing window collapses back into the in-situ preview content-browsing window with its loaded content restored back to the preview version. Like the in-situ preview content-browsing window expansion process, the collapse of the full-view content-browsing window back to the in-situ preview content-browsing window is aided by transition effects to generate visual cues for relating the in-situ full-view and the in-situ preview content-browsing windows.

Pushing the in-situ content exploration concept further, the present invention defines methods for a guest user to login as a designer such that he can edit the location-based content using in-situ preview and full-view content-editing windows. An in-situ preview content-editing window has similar geometry as an in-situ preview content-browsing window but it provides content-editing capabilities instead of just content-browsing capabilities. Similarly, an in-situ full-view content-editing window has similar geometry as an in-situ full-view content-browsing window but it also provides content-editing capabilities instead of just content-browsing capabilities. Because the in-situ preview content-editing window has a smaller geometry than the in-situ full-view content-editing window, it may offer a subset of the full-view content-editing window's editing features. However, both the in-situ preview and full-view content-editing windows are capable of editing both the preview and the full-view versions of the location-based content.

Both the in-situ preview and full-view content-editing windows provide a fluid, context-switching-free content editing experience that closely parallels most rich text editing environments allowing a user to edit rich text in-situ.

Pushing the in-situ content exploration concept further still, the present invention also defines methods for a guest user to login as an administrator such that he can monitor and administer content-change requests for publication from all users using the map surface as a dashboard. In particular, an administrator can explore the location-based content by using the same in-situ preview and full-view content-browsing windows a normal guest user can, but an administrator also has the added capability to actively un-publish any published location-based content from any user should the administrator observe any impropriety associated with the published location-based content.

Moreover, the map-based user interface of the present invention provides content-change alerts to the administrator, and the administrator can then leverage the in-situ preview and full-view content-browsing windows as tools for inspecting the content-change requests for publication. Furthermore, the map-based user interface of the present invention also provides the administrator with accept and reject capabilities for the location-based content-change requests from all users.

### SUMMARY OF THE INVENTION

In a mainstream map-based user interface, when a user clicks on a map marker, an in-situ preview content-browsing window associated with the map marker opens to show a preview version of the location-based content near the map marker, but when a user wishes to explore the full version of the location-based content by clicking on a hyperlink inside the in-situ preview content-browsing window, the user is navigated away from the map-based context and into a new window displaying the full version of the location-based content, and as such, a visual context switch occurs and the flow of the location-based content exploration on the map surface becomes disruptive and frustrating.

The present invention defines software methods for enabling an end-to-end in-situ user experience for the browsing, editing, and administration of location-based content in a map-based user interface. By applying the present invention, the user experience of location-based content exploration on a map-based user interface becomes seamless, fluid, compact and integrated regardless of whether the user intends to browse, edit, or administer the location-based content on the map surface.

### BRIEF DESCRIPTION OF THE DRAWING

FIG. 1 illustrates a systems view of a user interacting with an exemplary client-server map-based application of the present invention involving a browser and a web server.

FIG. 2 further illustrates a systems view of the exemplary system of FIG. 1 where subsystems relevant to the present invention within the browser and the web server are described.

FIG. 3 illustrates the map-based user interface enabling a guest user to explore a map surface with four map markers placed on it.

FIG. 4 illustrates the map-based user interface enabling the guest user to open an in-situ preview content-browsing window aided by animation by clicking on one of the four map markers.

FIG. 5 and FIG. 6 illustrate the map-based user interface expanding the in-situ preview content-browsing window into the in-situ full-view content-browsing window aided by animation.

FIG. 7 illustrates the map-based user interface enabling the guest user to browse the expanded in-situ full-view content-browsing window overlaying the map surface.

FIG. 8 illustrates the map-based user interface enabling the guest user to log in as a designer and explore the designer-created map markers.

FIG. 9 illustrates the map-based user interface enabling the designer to switch between Browse and Edit modes and change his identity to a guest through respective sets of menu options.

FIG. 10 illustrates the map-based user interface enabling the designer to open an in-situ preview content-editing window by clicking on a map marker while in Edit mode.

FIG. 11 illustrates the map-based user interface enabling the designer to interact with an expanded in-situ full-view content-editing window overlaying the map surface.

FIG. 12 illustrates the map-based user interface enabling the designer to make content changes and publish the changed content through the in-situ full-view content-editing window.

FIG. 13 illustrates the map-based user interface enabling the designer to treat the map surface as a user interface of a map-based file system for location-based content.

FIG. 14 illustrates the map-based user interface providing a popup menu for the designer to create a new map marker on the map surface.

FIG. 15 illustrates the map-based user interface providing a popup menu for the designer to delete or adjust the location of an existing map marker on the map surface.

FIG. 16 illustrates the map-based user interface providing a popup menu for the designer to specify keywords that are tagged onto the selected map marker on the map surface.

FIG. 17 illustrates the map-based user interface providing a popup menu for the designer to select a clustered map marker in a map marker cluster to browse its associated location-based content.

FIG. 18 illustrates the map-based user interface providing a paging mechanism as a way for the designer to select the target location-based content to be loaded in the in-situ preview content-editing window when the designer clicks on the map marker cluster.

FIG. 19 illustrates the map-based user interface providing a paging mechanism as a way for the designer or guest user to select the target location-based content to be loaded in the in-situ preview content-browsing window when the user clicks on the map marker cluster.

FIG. 20 illustrates the map-based user interface enabling the guest user to log in as an administrator to monitor and control the integrity of the map markers and their associated location-based content published by all users.

FIG. 21 illustrates the map-based user interface enabling the administrator to switch between Monitor and Administer modes, and change his identity to any designer through respective sets of menu options.

FIG. 22 illustrates the map-based user interface enabling the administrator to receive a content-change request as a visual alert on a map marker and inspect its associated location-based content in an in-situ preview content-browsing window to decide whether to accept or reject the content-change request for publication.

FIG. 23 illustrates the map-based user interface enabling the administrator to inspect the location-based content associated with the content-change request in an in-situ full-view content-browsing window to decide whether to accept or reject the content-change request for publication.

FIG. 24 illustrates the map-based user interface enabling the administrator to receive a content-change alert on a map marker cluster and inspect the location-based content associated with the clustered map marker generating the alert in an in-situ preview content-browsing window to decide whether to accept or reject the content-change request for publication.

FIG. 25 illustrates a flowchart describing the map-based user interface's processing steps for providing map-based in-situ content exploration.

FIG. 26 illustrates the map-based user interface state diagram of the present invention and its associated capability differences provided to different user types.

### DETAILED DESCRIPTION OF THE INVENTION

The present invention is described with reference to the drawings, where like reference numerals are used to refer to like elements throughout.

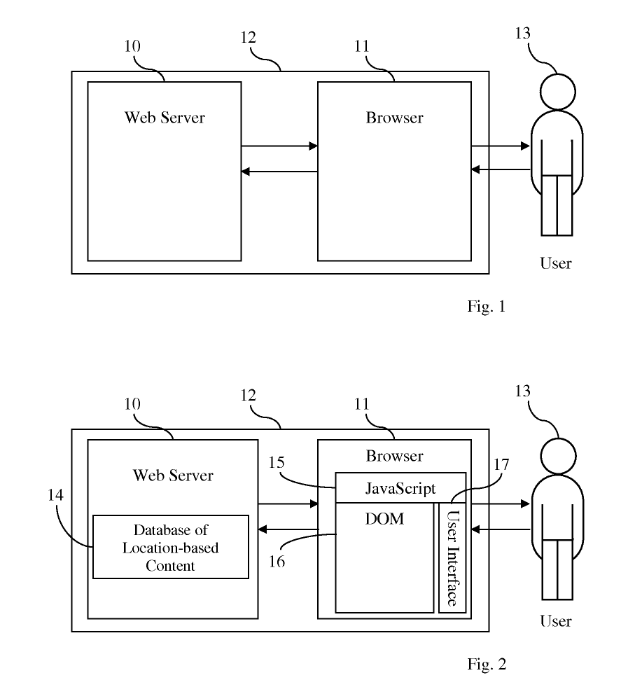

Leveraging the figures below, the following paragraphs provide detailed description to the present invention. FIG. 1 illustrates a block diagram that describes a user 13 interacting with an exemplary mapping system 12 that includes a browser 11 and a web server 10. In particular, a user 13 accesses the present invention through the web browser 11 as a map-based service supporting full end-to-end in-situ content exploration and management.

FIG. 2 illustrates a block diagram of the exemplary mapping system of FIG. 1 where relevant sub-blocks in the map browser 11 and the web server 10 of the mapping system 12 are described. In particular, within the web server 10, the database 14 illustrates the database management system used by the web server 10 for storing, indexing, and retrieving map markers and location-based content on a map surface. On the browser side, the JavaScript 15 sub-block illustrates the JavaScript execution engine of the map browser 11 where the user interface of the in-situ content exploration and management is implemented. The DOM 16 illustrates the HTML Document Object Model for the web page in the map browser 11, and in particular, all map markers and the in-situ preview and the full-view content-browsing windows are implemented as DOM elements. For example a content-browsing window can be implemented by an HTML IFRAME element. The map-based user interface 17 describes the HTML user interface presented to the user 13 for visualization and interaction.

Note that without going through any login procedure, the user 13 interacts with the map browser 11 as a guest user to browse and explore the location-based content stored in the database 14. In addition, the user 13 can login as a designer through the map browser 11 to create, edit, and publish location-based content stored in the database 14. Furthermore, the user 13 can login as an administrator through the map browser 11 to administer content-change requests for publication of location-based content created by any designer.

FIG. 3 illustrates the map-based user interface 17 being expanded in detail as the browser window 18. Inside the browser window 18, the top-left shows the current user label 25 displaying the default guest user. To the left of the user label 25 is a login button 24 and when the guest user clicks it a login dialog box 26 will appear. After entering the proper username and password credentials through the dialog box 26, the guest user can switch his user identity into either a designer or an administrator.

Still referring to FIG. 3, the background of the browser window 18 displays a geographical map 19, herein referred to as the map 19, at a zoom level controlled by the zoom control 28. On the surface of the map 19 are four exemplary map markers 20, 21, 22, and 23. The placements of the map markers 20, 21, 22, and 23 are purposeful as their locations relative to the background map indicate where the map markers' respectively associated location-based content is relevant in the physical real world. At the top right of the browser window 18 is a search box 27 where a physical address and content keyword information can be typed in and searched by the user. For example, if “Sydney, Australia” is typed into the search box 27 and the Search button is clicked, the center of the map surface 19 will be shifted towards Sydney of Australia and its zoom level will be adjusted to more properly show the details of the Sydney city. If “restaurant” is typed into the search box 27, the current map surface 19 will be populated with map markers associated with location-based content relevant to restaurants in Sydney.

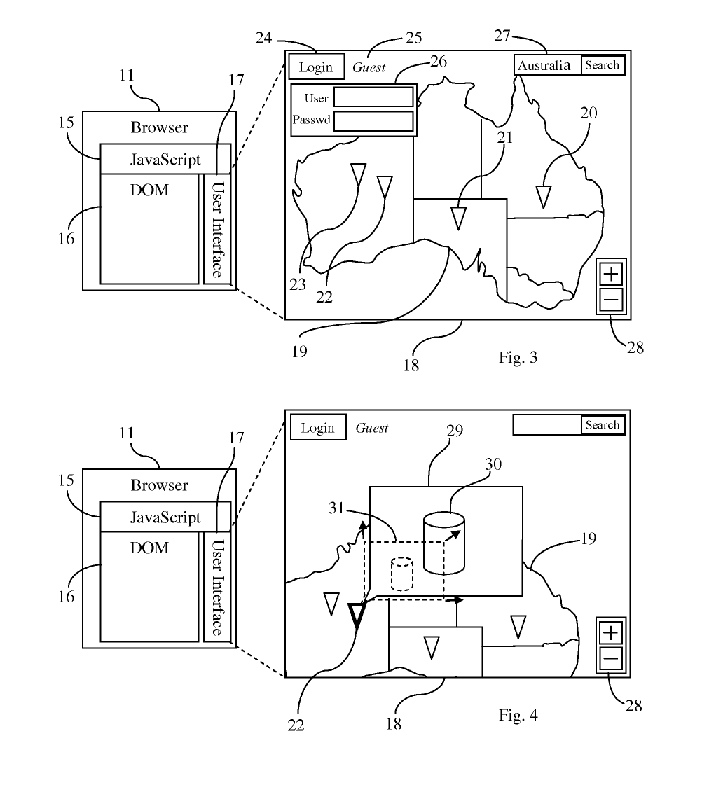

FIG. 4 illustrates the opening and displaying of an in-situ preview content-browsing window via animation after a user clicks on a map marker. In particular, FIG. 4 illustrates the opening and displaying of the in-situ preview content-browsing window 29 after a user clicks on the map marker 22. The map marker 22 becomes highlighted with a thick border and the in-situ preview content-browsing window 29 opens via animation and displays the location-based content 30 as a graphical object. In particular, the outline animator 31 generates the animation sequence that starts from a zero-size geometry located at the map marker 22 and ends as the geometry of the in-situ preview content-browsing window 29. The location-based content 30 also serves as a hyperlink for expanding the in-situ preview content-browsing window into an in-situ full-view content-browsing window. The animation effect generated by the outline animator 31 is referred to as outline-animation because only the salient approximation of the image or graphics of the display objects is animated in order to achieve a display high frame-rate.

Still referring to FIG. 4, the in-situ preview content-browsing window 29 typically serves a preview or overview purpose and as such its geometric size is usually small relative to the size of the browser window 18. However, even though an in-situ preview content-browsing window only occupies a small screen space, it nonetheless may display outside the browser window 18 and as such it may appear partially clipped. To remedy the clipped in-situ preview content-browsing window problem, the browser window 18 may scroll the entire map 19 and the in-situ preview content-browsing window 29 together until either the in-situ preview content-browsing window 29 is no longer clipped or the in-situ preview content-browsing window 29 is already centered relative to its containing browser window 18. In the case of FIG. 4, the in-situ preview content-browsing window 29 and the map surface 19 are shifted to the bottom left together such that the in-situ preview content-browsing window 29 is approximately centered relative to the browser window 18.

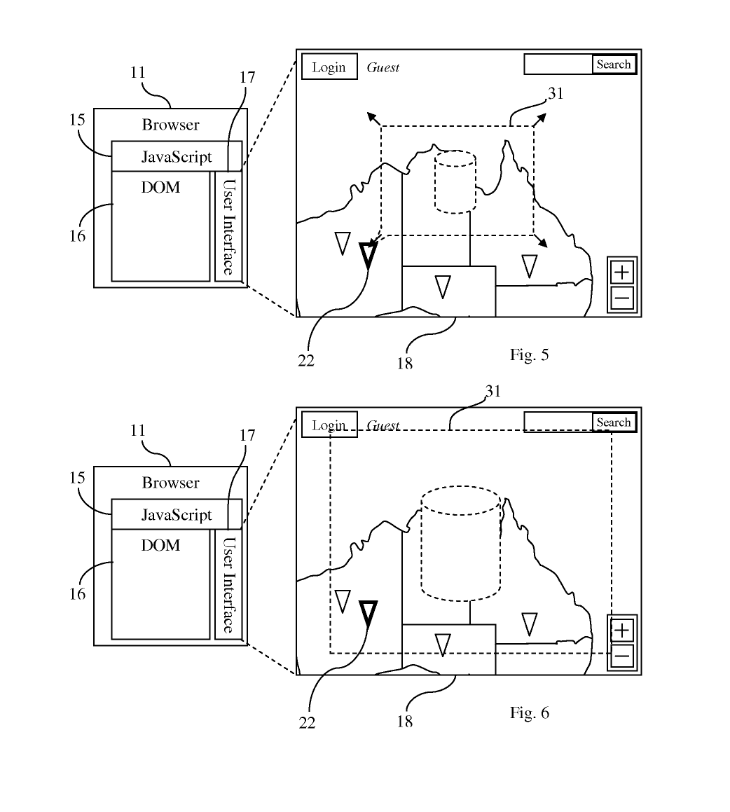

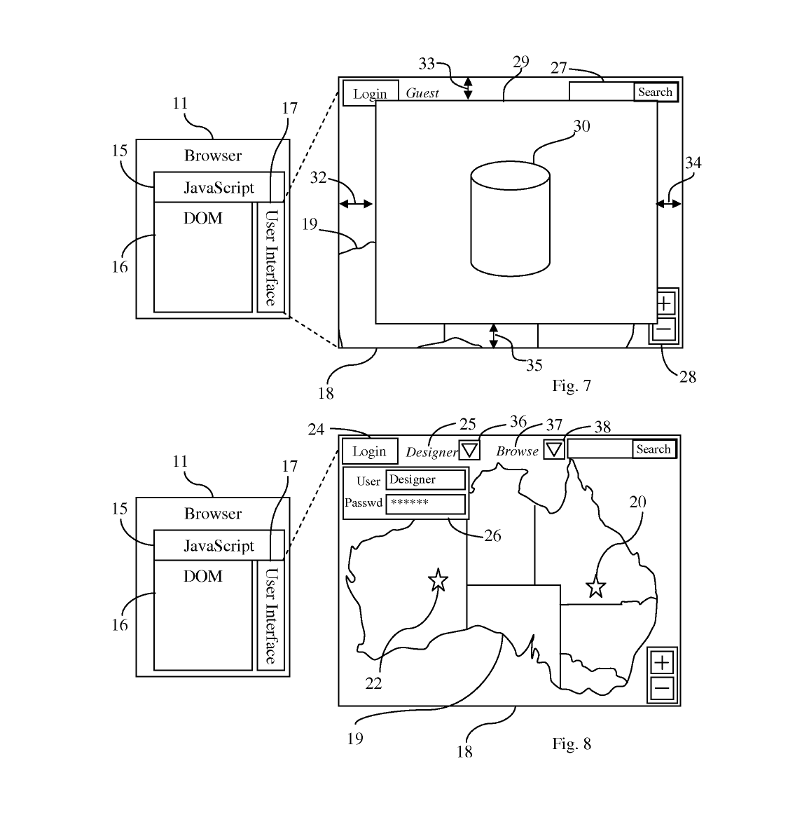

FIG. 5 and FIG. 6 illustrate the transition effect provided by the outline animator 31 during an animated expansion sequence that starts from the geometry of the in-situ preview content-browsing window 29 in FIG. 4 and ends as the geometry of the in-situ full-view content-browsing window 29 in FIG. 7. The outline animator 31 is described as “simulated” because only its appearance needs to approximate that of the in-situ preview content-browsing window 29 as the outline animator 31 is optimized for generating a smooth transition effect for the transformation between display objects. However, if the redisplay of the display objects is fast enough, the outline animator 31 can be discarded in favor of a design that animates the expansion and collapsing of the display objects directly. In particular, if the redisplay of the two versions of the content-browsing window 29 is fast enough, then both the animation sequence in FIG. 4 and in FIG. 5 can be achieved by successively scaling the content-browsing window 29 directly.

Still referring to FIG. 5 and FIG. 6, the transition effect generated by the outline animator 31 is triggered after the user clicks on the embedded location-based content 30 or clicks on the window frame of the in-situ preview content-browsing window 29. In particular, the outline animator 31 in FIG. 5 represents the first frame of the animation sequence while the outline animator 31 in FIG. 6 represents the last frame of the animation sequence. The number of interpolated frames between the first and the last frame in the animation sequence is configurable but as long as more than two interpolated frames are present the animation will substantially aid the perceptual correlation between the in-situ preview content-browsing window 29 in FIG. 4 and the in-situ full-view content-browsing window 29 in FIG. 7.

It is important to note that while FIG. 4, FIG. 5, and FIG. 6 only illustrate the animation involved in the expansion of the in-situ preview and full-view content-browsing window 29, the current invention stipulates that all expansion and collapsing of the preview and full-view content windows for browsing or editing be animated.

Still referring to FIG. 5 and FIG. 6, note that in an exemplary implementation of the present invention, the outline animator 31 may successively adjust its background transparency or apply other transition techniques to generate a smoother transition effect that visually connects the in-situ preview and full-view versions of the content-browsing window 29. The smoother the transition effect generated by the outline animator 31, the stronger the visual cue suggesting that the full-view content-browsing window 29 of FIG. 7 originates all the way from the map marker 22 and thereby reinforcing its in-situ expanding qualities.

FIG. 7 illustrates the guest user viewing the result of expanding the in-situ preview content-browsing window 29. The expansion transition effect of the in-situ preview content-browsing window 29 of FIG. 4 ends with the final geometry of the in-situ full-view window 29 being centered relative to the browser window 18 with adequate side gaps 32, 33, 34 and 35 between the other edges of the in-situ full-view content-browsing window 29 and the inner edges of the browser window 18. These side gaps are important as they reinforce the perceptual context being retained via the layering of the in-situ full-view content-browsing window 29 on top of the map surface 19.

It is important to note that an alternative in-situ window expansion may apply a 1-stage transition instead of the 2-stage transition previously described. In particular, with a 1-stage window expansion design, the preview content-browsing window 29 of FIG. 4 is skipped entirely and the transition effect starts at the map marker 22 with the content-browsing window 29 being a zero size window and ends with the content-browsing window 29 being the full-view content-browsing window 29 as in FIG. 7.

Still referring to FIG. 7, if the geometry of the browser window 18 is resized down, the gaps 32, 33, 34, and 35 need to be maintained and as such the geometry of the in-situ full-view content-browsing window 29 also needs to be resized down. In order to maintain the in-situ full-view content-browsing window 29's usability when it is resized down it may be necessary to create scrollbars vertically and horizontally to provide a way for the user to browse the full location-based content 30 when it is partially clipped. Alternatively, the in-situ full-view content-browsing window 29 can be configured to scale down the overall size of its location-based content 30 when both its own geometry and the browser window 18's geometry are resized down. In addition, the gaps 32, 33, 34, and 35 may be scaled down proportionately when the outer browser window 18 is resized down significantly in order to maximize the usable content space of the in-situ full-view content-browsing window 29.

Still referring to FIG. 7, if the outer browser window 18 is resized up, the gaps 32, 33, 34, and 35 still need to be maintained but can also be relaxed if the geometry of in-situ full-view content-browsing window 29 has reached its configured maximum width and height. Moreover, depending on its configuration, the in-situ full-view content-browsing window 29 may scale up the overall size of its location-based content 30 till a preset maximum scale factor is reached when both the in-situ full-view content-browsing window 29's and the browser window 18's geometry are resized up.

FIG. 8 illustrates the user 13 having logged into the map window 18 as a designer through the login dialog box 26 so that he can create, modify, and publish location-based content. In particular, the user label 25 shows the current user as a Designer. In addition, a dropdown menu control 36 is provided next to the user label 25 to let the designer switch identities between a designer and a guest user to explore either the designer-specific or the general map markers and their associated location-based content on the map surface 19. Furthermore, the mode label 37 shows that the browser window 18 currently lets the designer explore the map in the browse mode, and a dropdown menu control 38 is provided next to the mode label 37 to let the designer switch into edit mode or back into browse mode. When the browser window 18 is set in the designer-browse mode as in FIG. 8, only the map markers 20 and 22 created by the current designer are displayed on the map surface 19. To visually indicate the map markers are designer-created, the browser window 18 changed the look of the map marker icon from an inverted triangle into a star shape.

FIG. 9 illustrates the operations of the dropdown menu control 36 and 38 in more detail, and in particular, FIG. 9 illustrates the opening of the dropdown menus 39 and 40 corresponding to the dropdown menu controls 36 and 38 respectively. Moreover, the dropdown menu 39 allows the logged-in designer to switch back as a guest user to explore map markers and location-based content published by all users. The dropdown menu 40 allows the logged-in designer to switch between browse and edit modes. Similar to FIG. 8, FIG. 9 shows the designer setting the browser window 18 in the designer-browse mode, and as such, only the map markers 20 and 22 created by the current designer are displayed on the map surface 19.

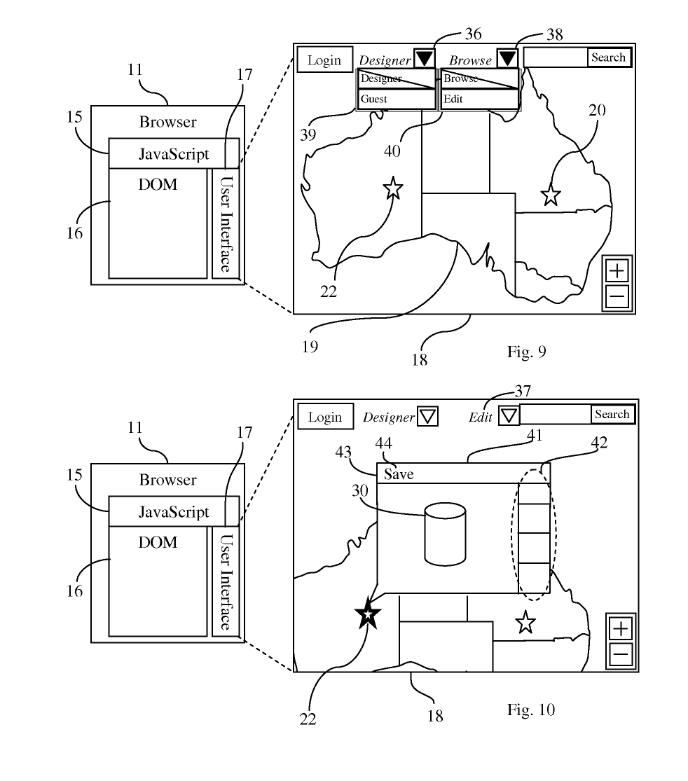

FIG. 10 illustrates the designer switching the browser window 18 from the browse mode to the edit mode as indicated by the mode label 37. Moreover, the designer also clicked on the map marker 22 of FIG. 9 to open an in-situ preview content-editing window 41. Since the browser window 18 now operates in edit mode instead of browse mode, instead of opening an in-situ preview content-browsing window, the browser window 18 now opens and displays an in-situ preview content-editing window 41 that is fully interactive and functional near the clicked map marker 22. Since the in-situ preview content-editing window 41's geometry is scaled down, it can only provide a subset of the editing features compared to a full-window editor for editing the location-based content 30 associated with the map marker 22.

Still referring to FIG. 10, the purpose of the in-situ preview content-editing window 41 is two-fold. First, the in-situ preview content-editing window 41 provides the designer with a quick and non-intrusive way to confirm the displayed location-based content is what the designer intends to view and edit without requiring the user to pay the computational delay and visual burden of opening a full-window editor. Second, the in-situ preview content-editing window 41 provides the designer with a light-weight method to access simple and frequently-used editing features of a full-window editor. Examples of simple and frequently used editing features include adjusting the geometry and changing the text of location-based content. Because the in-situ preview content-editing window 41 is fully interactive and functional, a set of editing tools on the tool panel 42 is provided to the designer for making changes to the location-based content 30. Similarly, a menu bar 43 is provided in the preview content-editing window 41 to enable the designer to make menu-driven changes to the location-based content 30. In particular, a save button 44 is provided in the menu bar 43 for the designer to save the changed location-based content 30 to the database 14 of the web server 10.

FIG. 11 illustrates the designer expanding the in-situ preview content-editing window 41 of FIG. 10 into the in-situ full-view content-editing window 41 for editing the location-based content 30. The user interface gesture to trigger the expansion of the in-situ preview content-editing window 41 into the in-situ full-view content-editing window 41 can be the designer clicking on the map marker 22 of FIG. 10 or the designer clicking on the window frame of the in-situ preview content-editing window 41, or the designer going through some other interactive gestures on the content of the content-editing window 41.

Still referring to FIG. 11, when compared to the in-situ preview content-editing window 41 of FIG. 10, the in-situ full-view content-editing window 41 is allocated much more window space and being a full editing window it provides a full set of editing tools 42 for editing the location-based content 30. Also, compared to the scaled down location-based content 30 of FIG. 10, the in-situ full-view content-editing window 41 attempts to show the location-based content 30 at a scale factor of 1 unless the containing browser window 18 is resized down.

Still referring to FIG. 11, the gaps 50, 51, 52, and 53 need to be maintained between the outer edges of the in-situ full-view content-editing window 41 and the inner edges of the containing browser window 18 similar to the gaps 32, 33, 34, and 35 for the full-view content-browsing window 29 of FIG. 7. As a result, if the containing browser window 18 is resized down, the geometry of the in-situ full-view content-editing window 41 also needs to be resized down which will force the scaling-down of the location-based content 30 unless the full-view content-editing window 41 is configured to always display the full location-based content 30 without scaling, in which case horizontal and vertical scrollbars will be added to the full-view content-editing window 41 to prevent the location-based content 30 from visually overflowing the full-view content-editing window 41.

Still referring to FIG. 11, compared to the menu bar 43 of FIG. 10, a full set of menu options is provided in the full-view content-editing window 41. In particular, besides the save button 44, a publish menu 45 with a full-view menu option 46 and a preview menu option 47 are provided to let the designer publish the location-based content 30 either as a full-view version or a preview version. These two menu options enable the designer to submit the published content as a content-change request for publication to a location-based content administrator. In addition, a keywords menu 48 allows the designer to specify the keywords in the input field 49. The specified keywords will be tagged with the location-based content 30 when it is saved into the database 14 of the web server 10, and in particular, the keyword “Hotel” is entered into the input field 49. The tagged keywords will assist the searching and retrieval of the location-based content 30 from the database 14 when the user 13 specifies closely matched keywords in the search box 27.

It is important to note that an alternative in-situ content-editing window expansion may apply a 1-stage transition instead of the 2-stage transition previously described. In particular, with a 1-stage content-editing window expansion design, the preview content-editing window 41 of FIG. 10 is skipped entirely and the transition effect starts at the map marker 22 with the content-editing window 41 being a zero size window and ends with the content-editing window 41 being the full-view content-editing window 41 as shown in FIG. 11.

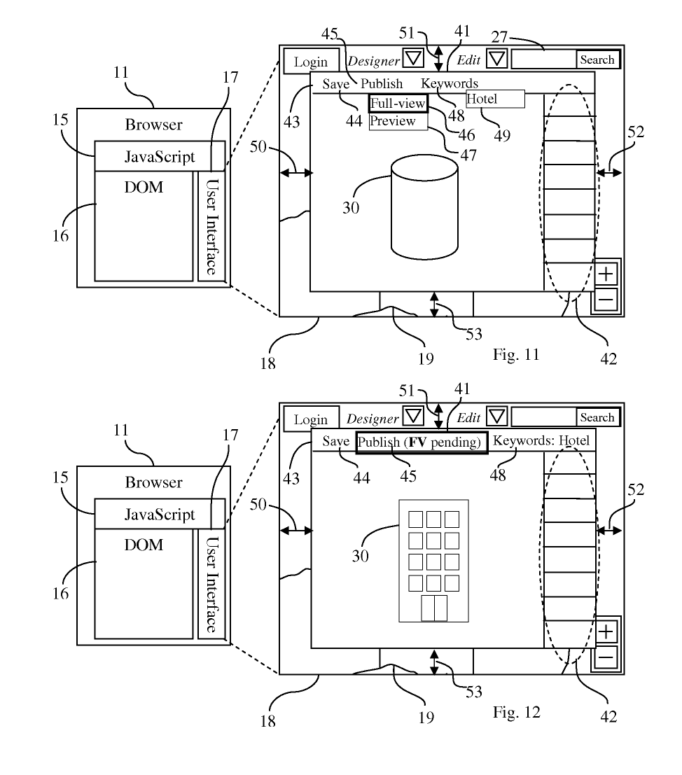

FIG. 12 illustrates the designer having changed the location-based content 30 to make it look more like a hotel through the full-view content-editing window 41. Moreover, the designer has submitted a content-change request for publication through the full-view menu option 46 of the publish menu 45 of FIG. 11. As a way to indicate the status of the content-change request, the label of the publish menu 45 has changed to “Publish (FV pending)” to indicate the fact that an outstanding content-change request for the designer is in progress with “FV” indicating it's a full-view content-change request. In addition, the label for the Keywords menu 48 has been changed to “Keywords: Hotel” to indicate the fact that the keyword “Hotel” has been tagged with the location-based content 30.

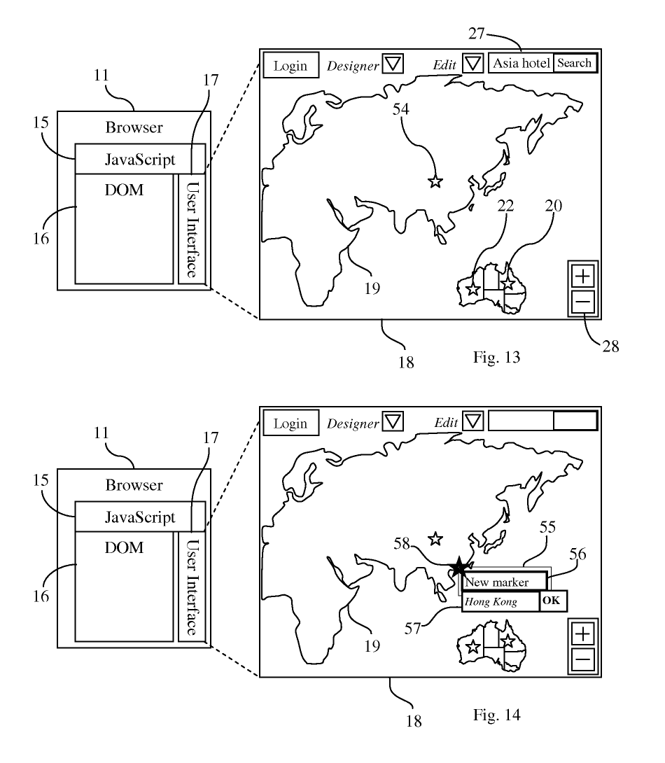

FIG. 13 to FIG. 19 illustrate how the use of the map markers placed on the map surface inside the browser window 18 together with the zoom control 28 and map marker clustering effectively transforms the map browser 18 into a map-based file system user interface for managing map markers and their associated location-based content. In particular, if a designer wishes to find all the location-based content he has created, he can simply zoom out far enough to visualize significant portions of the planet Earth using the zoom control 28 such that all the map markers created by him all come into view as shown in FIG. 13. Specifically, compared to FIG. 8 where only the Australian continent and the two map markers 20 and 22 are displayed in the browser window 18, the browser window 18 shown in FIG. 13 shows the entire continent of Asia plus the continent of Australia and the three designer-created map markers 20, 22, and 54. If the map surface 19 in the browser window 18 is zoomed out further such that all the world's continents are shown then all the map markers created by the designer on the planet Earth will be shown.

Besides searching for locations, it is important to note that the search box 27 also serves the keyword-search function for location-based content associated with map markers on the map surface. For example, if the designer enters “Asia hotel” into the search box 27 and clicks the Search button, the map surface 19 will be adjusted to show the Asia region only. Moreover, the map markers created by the designer falling within the local Asia region will be filtered such that only those with the associated location-based content relevant to the “hotel” keyword will be shown. The implementation of the map-based keyword search function can be implemented by the JavaScript 15 of the browser 11 or by the database 14 of the web server 10.

FIG. 14 illustrates the browser window 18 providing the designer with a way to create a new map marker at a designated location. In particular, when the designer right-clicks on the map surface 19, the context menu 55 is opened with the “New marker” menu option 56, and when the designer chooses it, an input field 57 is displayed to enable the designer to enter the designated location for the new marker. FIG. 14 shows that the designer entered “Hong Kong” in the input field 57 and hit the OK button, and a new map-marker 58 located at Hong Kong is created on the map surface 19. Note that the map-marker 58 will acquire a default name of “Hong Kong”. The naming of the map-marker 58 can also be achieved directly by specially formatted string entered in the input box 57. For example, a “Hong Kong (HK1)” string entered in the input box 57 can be interpreted as a command for creating a new marker at the location Hong Kong with a map marker named “HK1”.

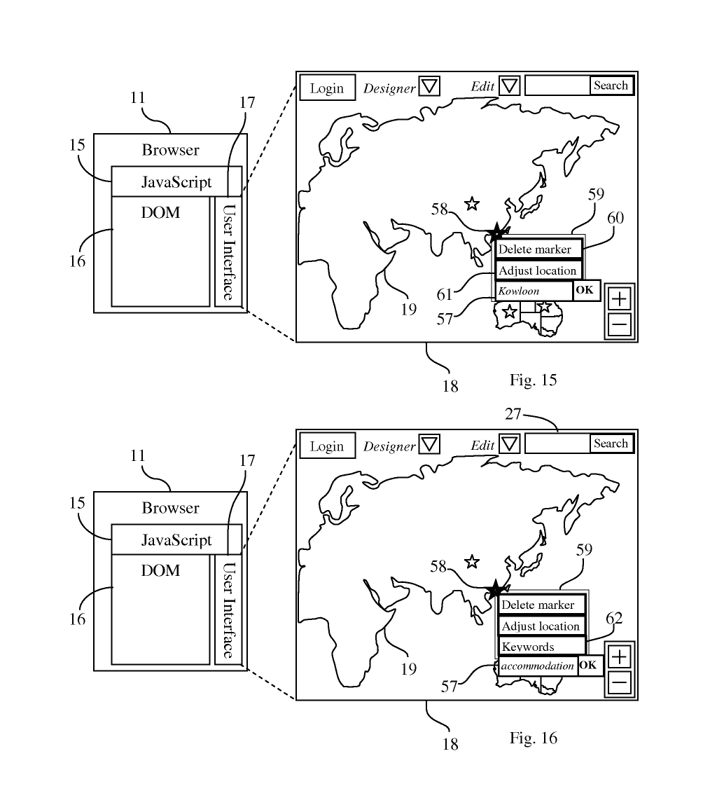

FIG. 15 illustrates the browser window 18 providing the designer with a way to delete and adjust the location of a selected map marker. In particular, when the designer right-clicks on the map marker 58, the context menu 59 is opened with the “Delete marker” menu option 60 and the “Adjust location” menu option 61. If the designer chooses the menu option 60, the selected map marker 58 will be deleted from the map surface 19. If the designer chooses the menu option 61, the input field 57 will be displayed to enable the designer to enter the new location for the selected map marker 58. FIG. 15 shows that designer entered “Kowloon” in the input field 57 and after the designer clicks the OK button, the map-marker 58 will be adjusted to locate at Kowloon on the map surface 19. Note that the map-marker 58 will also be renamed to “Kowloon” by default.

FIG. 16 illustrates the browser window 18 providing the designer with a way to tag keywords directly onto a selected map marker. In particular, when the designer right-clicks on the map marker 58, the context menu 59 is opened with the “Keywords” menu option 62 and if the designer chooses it, the input field 57 will be displayed to enable the designer to enter keywords that will be tagged with the selected map marker 58. The tagged keywords will be saved into the database 14 of the web server 10 and will be used to assist the search for map markers should closely-matched keywords be entered into the search box 27.

FIG. 16 shows that the designer entered “accommodation” in the input field 57 and after the designer clicks the OK button, the keyword “accommodation” can be entered into search box 27 and all map markers except the map-marker 58 will be filtered from the map surface 19. It is important to note that the map marker keywords entered through the menu option 62 and the location-based content keywords entered through the input box 49 of FIG. 11 are saved and treated separately by the database 14, but when a keyword is entered into the search box 27, the database 14 will compute and utilize the keywords of the associated location-based content in addition to those directly tagged to the map markers to produce the resulting map markers to be shown on the map surface 19.

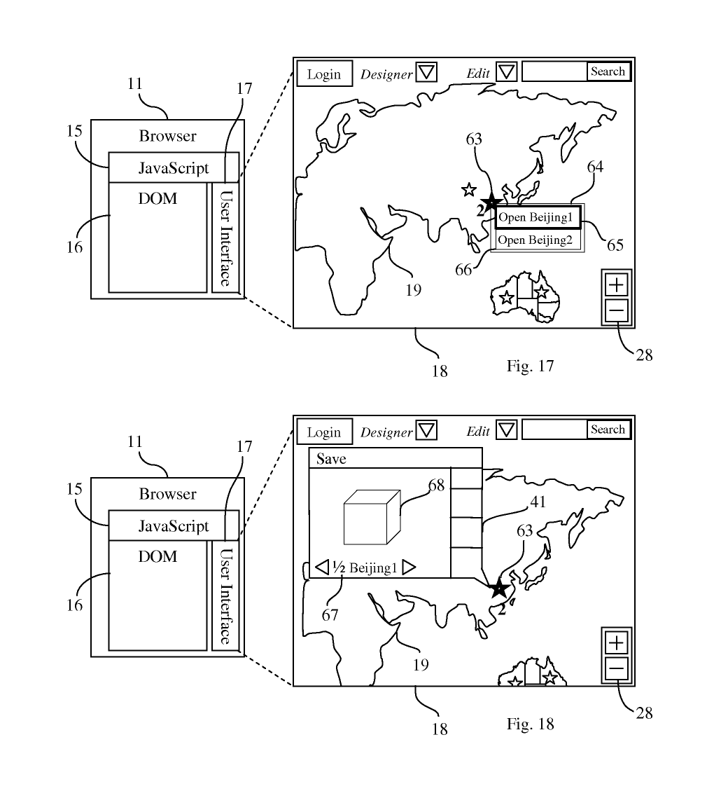

At any zoom level as controlled by the zoom control 28, map markers may overlap each other and makes the ones completely obscured at the bottom inaccessible. FIG. 17 illustrates the user-interface features provided by the browser window 18 to expose obscured map markers. In particular, when two or more map markers are very closely located on the map surface 19, they are clustered together by the browser window 18 as one map marker called a map marker cluster. The map marker cluster 63 is such an example and note that the map marker cluster 63 has a label “2” to indicate that it clusters two map markers. When the designer clicks on the map marker cluster 63, instead of directly opening the preview content-editing window 41, the browser window 18 highlights the map marker cluster 63 and provides a context menu 64 with the “Open . . . ” menu options where each menu option corresponds to a respectively clustered map marker. In particular, the “Open Beijing1” menu option 65 and the “Open Beijing2” menu option 66 are provided, indicating that there are two clustered map markers at the location of the map marker cluster 63, with one associated with the clustered map marker named “Beijing1” and the other associated with clustered map marker named “Beijing2”. For FIG. 17, the designer selects the “Open Beijing1” menu option 65.

Furthermore, when the in-situ preview and full-view content-editing window opens for a map marker cluster, a paging-mechanism is provided in the content-editing windows to enable the designer to select the location-based content related to a target clustered map marker to edit. As an example, FIG. 18 shows that when the in-situ preview content-editing window 41 opens for the map marker cluster 63, the in-situ preview content-editing window 41 loads the “Beijing1” location-based content 68 and a paging control 67 is provided in the in-situ preview content-editing window 41 to enable the designer to select and open either the location-based content associated with the clustered map marker “Beijing1” or the clustered map marker named “Beijing2”. Note that the paging control 67 is also provided in the full-view location-based content editing window 41 should the preview content-editing window 41 of FIG. 18 be expanded.

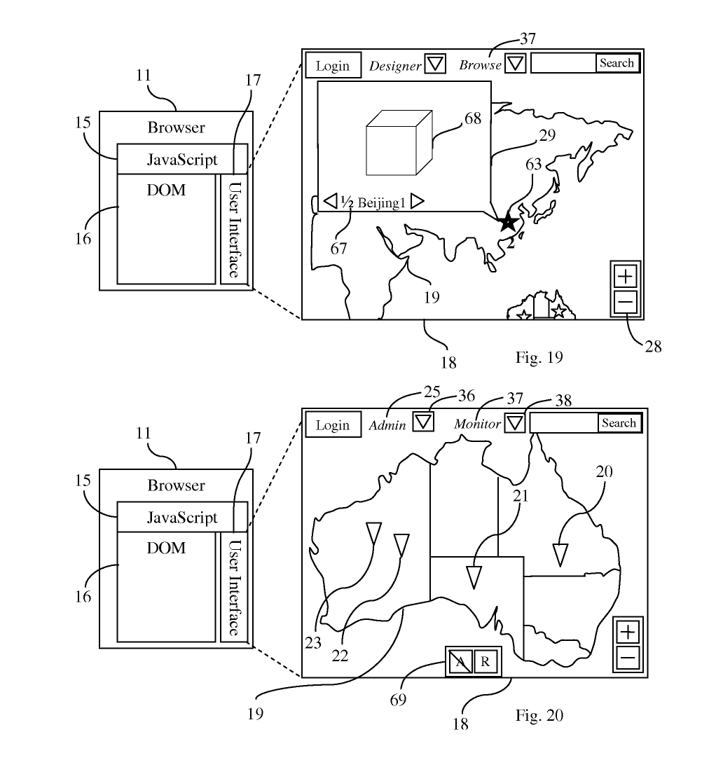

More generally, when the in-situ preview and full-view content-browsing windows open for a map marker cluster for a designer or a guest user, a paging-mechanism is provided in the content-browsing windows to enable the designer or guest user to select the location-based content related to a target clustered map marker to browse. As an example, FIG. 19 shows that the designer switching the browser window 18 into the browse mode as indicated by the mode label 37, and when the in-situ preview content-browsing window 29 opens and displays the location-based content 68 for the first clustered map marker named Beijing1, the paging control 67 is also provided in the in-situ preview content-browsing window 29 to enable the designer to page through the rest of the location-based content associated with the clustered map markers of the map marker cluster 63. Similarly, if a full-view content-browsing window 29 is expanded for a map marker cluster 63, the paging control 67 is also provided for content-paging purposes.

FIG. 20 illustrates the user 13 having logged into the map window 18 as a location-based content administrator such that he can monitor published location-based content and administer location-based content-change requests for publication from all users. In particular, the user label 25 shows the current user as an “Admin” which is short for administrator. In addition, the dropdown menu control 36 next to the user label 25 is provided to let the administrator switch to any designer so that the administrator can investigate issues related to the designer's published location-based content. Furthermore, the mode label 37 shows that the browser window 18 currently operates in the monitor mode. The dropdown menu control 38 next to the mode label 37 is provided to let the administrator switch between administer and monitor mode.

Still referring to FIG. 20, the browser window 18 operates in the admin-monitor mode and as such, the map markers 20, 21, 22, and 23 from all designers are displayed on the map surface 19. In addition, an approval control 69 with an “A” and an “R” button are created and it is used by the administrator for approving or rejecting content-change requests for publication respectively.

Still referring to FIG. 20, the browser window 18 operates in the admin-monitor mode, and the administrator is free to browse any location-based content already published by any designer just like a guest user would but the administrator can also actively “un-publish” any location-based content should any impropriety associated with the location-based content be observed. Since no content-change requests for publication are processed by the browser window 18 in the admin-monitor mode, the “A” button for approving is disabled and only the “R” button for rejecting, or in this case un-publishing, the published location-based content in the approval control 69 is enabled.

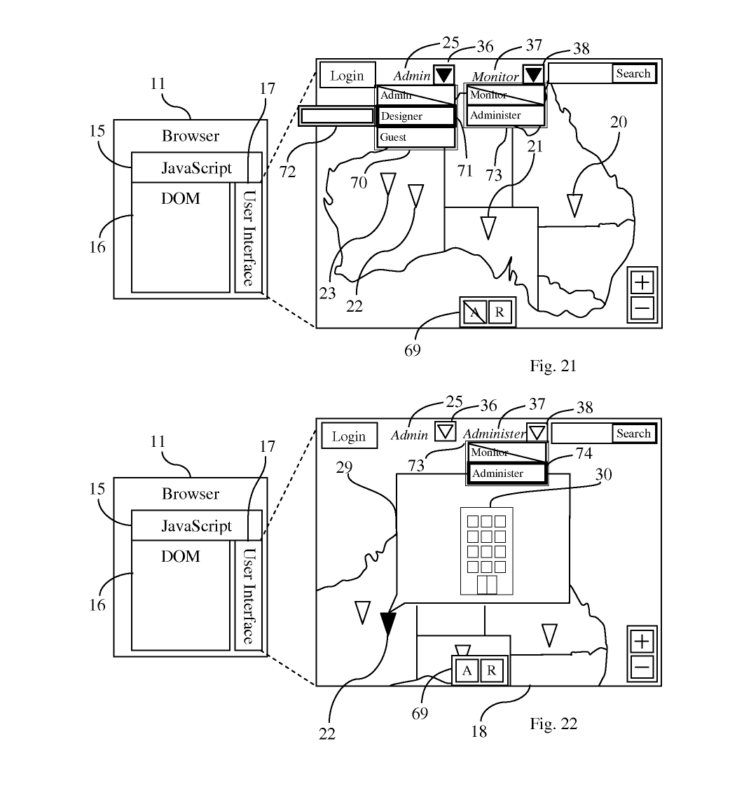

FIG. 21 illustrates the dropdown controls of 36 and 38 for the administrator. In particular, if the administrator clicks on the dropdown control 36, the dropdown menu 70 will be opened to enable the administrator to switch his identity to any designer. The specification of a target designer is achieved through an input box 72 when the administrator mouses over the menu option 71. In addition, the administrator can use the dropdown menu 70 to switch his identity to a guest to browse the map markers and location-based content published by all users without the approval control 69. Furthermore, the administrator can also use the dropdown menu 70 to switch his identity back to the original administrator for monitor and administer purposes.

Still referring to FIG. 21, if the administrator clicks on the dropdown control 38, the dropdown menu 73 will be opened to enable the administrator to switch between the monitor and the administer mode.

FIG. 22 illustrates the administrator switching the browser window 18 from the monitor mode to the administer mode by selecting the menu option 74 of the dropdown menu 73. While operating in the administer mode as indicated by the mode label 37, the browser window 18 becomes a monitor-and-control dashboard for incoming location-based content-change requests submitted by any designers. In FIG. 22, the map marker 22 blinks by alternating its display icon between a solid inverted triangle and a hollow inverted triangle to alert the administrator that a pending content-change request is detected on its associated location-based content. When the administrator clicks on the map marker 22, the browser window 18 opens the in-situ preview content-browsing window 29 with a similar geometry compared to the in-situ preview content-browsing window 29 of FIG. 4. After the in-situ preview content-browsing window 29 opens the map marker 22 turns into an inverted triangle with a solid background without blinking to indicate that the location-based content 30 with the content-change request is being inspected for publication approval from the administrator. As such both the “A” button for approving and the “R” button for rejecting in the approval control 69 are enabled and the administrator can decide whether the modified location-based content 30 shown inside the in-situ preview content-browsing window 29 is proper for publication. If the administrator approves the changed content 30, he will click the “A” button of the approval control 69. If the administrator disapproves the changed content 30, he will click the “R” button of the approval control 69.

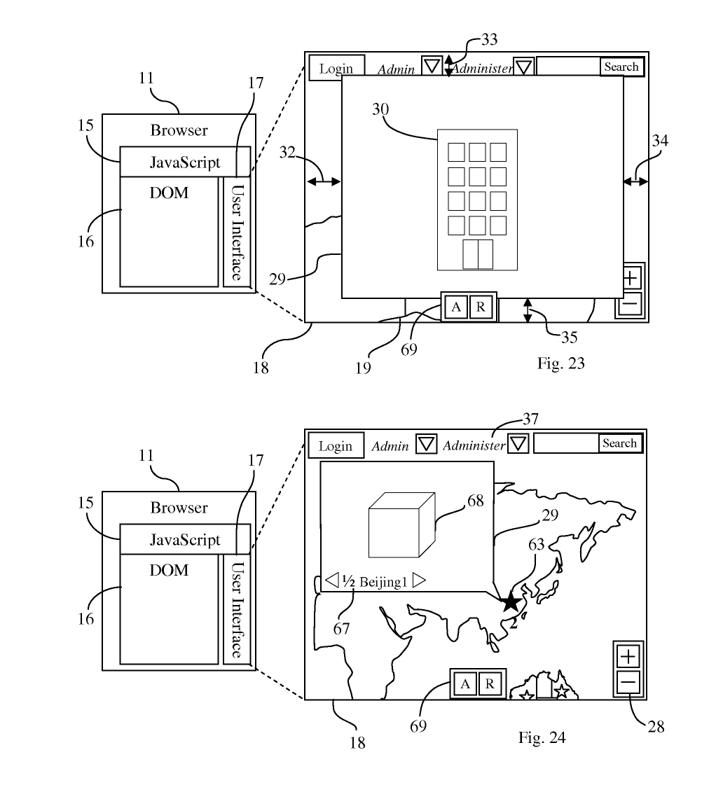

FIG. 23 illustrates the administrator having expanded the in-situ preview content-browsing window 29 of FIG. 22 into the in-situ full-view content-browsing window 29 for displaying the full version of the modified location-based content 30 of the map marker 22. The gesture for expanding the in-situ preview content-browsing window 29 may involve clicking on the location-based content 30 of FIG. 22 or by clicking on the map marker 22. Also, similar to the gaps 32, 33, 34, and 35 of the full-view content-browsing window 29 of FIG. 7, the gaps 32, 33, 34, and 35 need to be maintained between the outer edges of the full-view content-browsing window 29 and the inner edges of the containing browser window 18 to reinforce the in-situ layering of the full-view content-browsing window 29 being on top of the map surface 19 visually.

FIG. 24 illustrates a map marker cluster generating a content-change alert if any one of its clustered map markers contains one. In particular, FIG. 24 shows that the map marker cluster 63 blinks as a result of its contained clustered map marker named Beijing1 is associated with a content-change request. When the administrator clicks on the map marker cluster 63, the browser window 18 opens the in-situ preview content-browsing window 29 that is preloaded with the location-based content associated with the clustered map marker named Beijing1. After the in-situ preview window 29 opens the map marker cluster 63 is drawn with a solid background without blinking to indicate that the clustered location-based content 68 with the content-change request is being inspected for publication approval from the administrator. As such both the “A” button for approving and the “R” button for rejecting in the approval control 69 are enabled and the administrator can decide whether the modified location-based content 68 shown inside the in-situ preview content-browsing window 29 is proper for publication. Note that if the administrator adjusts the loaded location-based content via the paging control 67 in the in-situ preview content-browsing window 29 to anything other than the clustered location-based content 68, the loaded content will not be associated with a content-change request and the “A” button of the approval control 69 will be disabled.

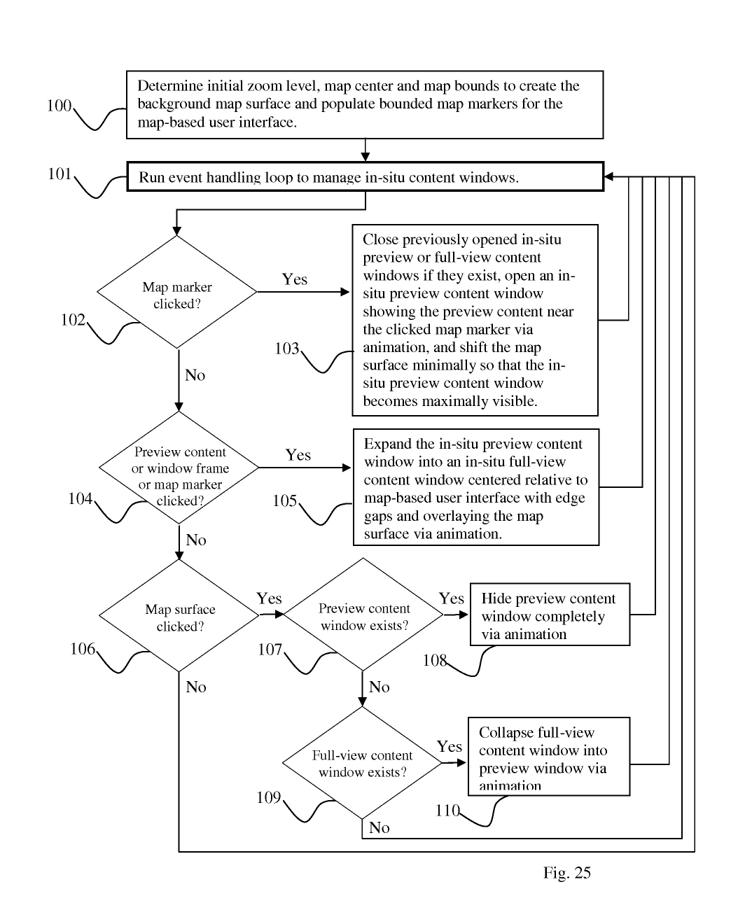

FIG. 25 illustrates the flowchart of the key steps involved in the map-based user interface for providing the end-to-end in-situ location-based content exploration. The term content window is used to refer to both content-browsing and content-editing windows. In particular, the step 100 describes the first step where the map-based user interface sets the initial zoom level, the map center and the map bounds in longitude and latitude in order to create and display the proper map surface for the map-based user interface. The map surface is then populated with map-markers bounded by the map bounds.

The step 101 describes the next step where the map-based user interface runs an event-handling loop to display and manage in-situ content windows.

The step 102 describes a conditional step that checks whether a map marker has been clicked, and if the answer is yes, execution continues at the step 103 where the map-based user interface responds by first closing any previously opened in-situ preview or full-view content windows if they exist. Then the map-based user interface opens an in-situ preview content window showing the preview version of the location-based content of the clicked map marker at a location near the clicked map marker via animation. Finally the map-based user interface shifts the map surface and the in-situ preview content window together minimally such that the in-situ preview content window becomes maximally visible. At the end of the step 103, execution flows back to the event loop described by step 101. If the result of the conditional step 102 is no, execution continues at the conditional step 104.

It is important to note that while the preferred implementation of the map-based user interface encourages that at most one in-situ preview content window or one full-view content window is opened at a time, it does not preclude other multi-opened in-situ content window designs. Note that all expansion and collapsing operations between a map marker and an in-situ preview content window, and between an in-situ preview content window and an in-situ full-view content window, are animated to reinforce the correlations between them visually.

The conditional step 104 describes the next conditional step that checks whether the in-situ preview content, or its window frame, or the map marker associated with the in-situ preview content window has been clicked, and if the answer is yes, execution continues at the step 105 where the in-situ preview content window expands into an in-situ full-view content window centered relative to the map-based user interface window overlaying the map surface with gaps between the outer edges of the full-view content window and the inner edges of the map-based user interface window via animation. At the end of the step 105, execution flows back to the event loop described by step 101. If the result of the conditional step 104 is no, execution continues at the step 106.

The conditional step 106 describes the next conditional step that checks whether the map surface is clicked, and if the answer is yes, execution continues at the next conditional step 107 that checks whether any in-situ preview content window exists, and if the answer is yes again, execution continues at the step 108 which collapses and hides the opened in-situ preview content window completely via animation. At the end of the step 108, execution flows back to the event loop described by step 101.

If the result of the conditional step 107 is no, execution continues at the conditional step 109 that checks whether any in-situ full-view content window exists, and if the answer is yes, execution continues at the step 110 which collapses the opened in-situ full-view content window into an in-situ preview content window via animation. At the end of the step 110, execution flows back to the event loop described by step 101.

If the result of the conditional step 106 or 109 is no, execution flows back to the event loop described by step 101.

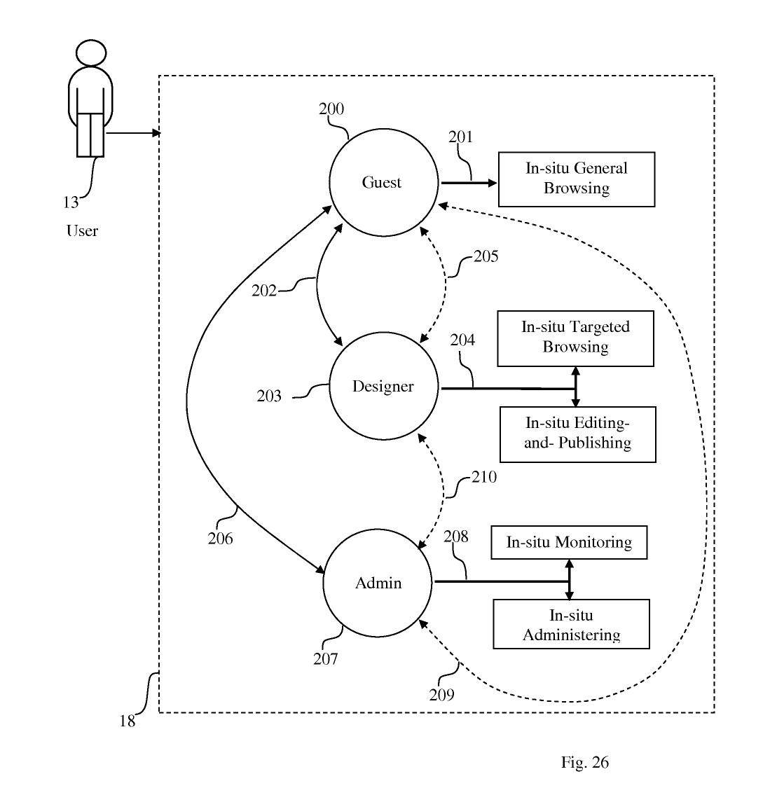

FIG. 26 illustrates the state diagram of the browser window 18 associated with the present invention from the system's point of view. FIG. 26 also illustrates capability differences associated with the browser window 18 as the user 13 operates it as a guest user, a designer, and an administrator to explore and manage the location-based content. In particular, when the user 13 accesses the browser window 18 associated with the present invention, his default identity is a guest user as described by the browser window 18 operating in the default guest state 200. While operating in the guest state 200 the browser window 18 provides the user 13 with in-situ general browsing capability through the capability-provisioning path 201. The in-situ general browsing capability refers to the browser window 18 providing browsing capability for location-based content associated with map markers published by all users through the in-situ preview and the in-situ full-view content-browsing windows.

Still referring to FIG. 26, if the user 13 logins as a designer as described by the login path 202, the browser window 18 changes state to the designer state 203. The browser window 18 provides the user 13 acting as a designer with the in-situ targeted browsing and the in-situ editing-and-publishing capabilities through the capability-provisioning path 204. The in-situ targeted browsing capability refers to the browser window 18 providing browsing capability for location-based content published by the logged-in designer only using the in-situ preview and in-sit full-view content-browsing windows. The in-situ editing-and-publishing capability refers to the browser window 18 providing content-editing-and-publishing capabilities for location-based content created by the logged-in designer using the in-situ preview and full-view content-editing windows. In particular, the content-publishing capability refers to the browser window 18 letting the designer submit a saved location-based content as a content-change request for publication to a location-based content administrator.

The login path 202 is bi-directional because it also describes the browser window 18 enabling the user 13 acting as a designer to switch his role back into a guest through a logout step, and the browser window 18 changing state back into the guest state 200 as a result. The state-change path 205 refers to the browser window 18 enabling the user 13 acting as a designer to switch his role back and forth between a designer and a guest without the logout/login step, and the browser window 18 switching state between the designer state 203 and the guest state 200 as a result. Note that the state-change path 205 is drawn dotted to indicate the fact that only when the user 13's real identity is a designer or an administrator can he take advantage of this state-change path.

Still referring to FIG. 26, if the user 13 logins as a location-based content administrator as described by the login path 206, the browser window 18 changes state to the admin state 207 and the browser window 18 provides the user 13 with the in-situ monitoring and the in-situ administering capabilities through the capability-provisioning path 208. The in-situ monitoring capability refers to the browser window 18 providing the user 13 acting as an administrator with reject capability during general browsing of location-based content published by any user using the in-situ preview and the full-view content-browsing windows. The in-situ administering capability refers to the browser window 18 providing the user 13 acting as an administrator with content-change alerts, approve-reject capabilities for content-change requests submitted by any user, and content-inspection capability using the in-situ preview and full-view content-browsing windows as inspection windows.

The login path 206 is bi-directional because it also describes the user 13 acting as an administrator switching his role back into a guest through a logout step and the browser window 18 changing state back into the guest state 200. The state-change path 209 refers to the browser window 18 enabling the user 13 acting as an administrator to switch his role back and forth between an administrator and a guest without the logout/login step, and the browser window 18 switching state between the admin state 207 and the guest state 200 as a result. Note that the state-change path 209 is drawn dotted to indicate the fact that only when the user 13's real identity is an administrator can he take advantage of this state-change path. While operating in the guest state 200, the browser window 18 lets the administrator acting as a guest browse location-based content from all users while suppressing the in-situ monitoring and the in-situ administering capabilities.

Because an administrator has the highest capability privileges, an administrator can also choose to operate the browser window 18 as any designer for administrative purposes, and this capability is provided by the browser window 18 as described by the state-change path 210. In particular, the state-change path 210 refers to the browser window 18 enabling the user 13 acting as an administrator to switch his role back and forth between an administrator and a selected designer without the logout/login step, and the browser window 18 switching state between the admin state 207 and the designer state 203 as a result. Note that the state-change path 210 is drawn dotted to indicate the fact that only when the user 13's real identity is an administrator can he take advantage of this state-change path.

All provisioned capabilities by the browser window 18 are described as in-situ because the user 13 is enabled to apply these provisioned capabilities without leaving the map-based context.

The present invention defines methods for map-based user interfaces to provide end-to-end in-situ exploration and management of location-based content. In a traditional map-based user interface, only the preview location-based content is shown inside an in-situ preview content-browsing window when a user clicks on a map marker. To view the full detail of the location-based content associated with the clicked map marker, the user is navigated away from the map to a full version of the location-based content shown in a new window. This navigation makes the user's viewing experience disruptive and frustrating because it forces the user to leave the original map-based context. In contrast, the present invention defines methods to enable the user's content-exploration experience to stay within the map-based context even when the full-view location-based content is viewed. Furthermore, the present invention defines methods to enable the user's content-editing and content-administration experiences to stay within the map-based context.

In conclusion, the present invention defines end-to-end in-situ methods that dramatically improve the user-experience continuity and computational efficiency during location-based content exploration, editing, and administration.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

What is claimed is:

1) A method for viewing content associated with a map marker displayed on a map surface comprising:
a) a map-based user interface creating and positioning a map marker on a map surface of real-world geographical region where said map marker is associated with location-based content relevant to said map marker's position on said map surface.
b) said map-based user interface letting a user apply an interactive gesture on said map marker to open a small preview content-browsing window that is layered on-top of said map surface and displaying a preview version of said location-based content.
c) said map-based user interface providing means for letting said user apply an interactive gesture on said small preview content-browsing window to expand it into a full-view content-browsing window that is layered on-top of said map surface and displaying a full version of said location-based content.

2) The method of claim 1 further comprising:
a) said map-based user interface generating a transition effect between said map marker and said preview content-browsing window during the opening of said preview content-browsing window.

3) The method of claim 1 further comprising:
a) said map-based user interface generating a transition effect between said preview content-browsing window and said full-view content-browsing window during the expansion of said full-view content-browsing window.

4) The method of claim 1 further comprising:
a) spatial gaps between the outer edges of said full-view content-browsing window and the inner edges of said map-based user interface window such that said map surface under said full-view content-browsing window can be partially visible.

5) The method of claim 1 further comprising:
a) said map-based user interface clustering said map markers located in close proximity to each other as a map marker cluster on said map surface.
b) said map-based user interface providing means for letting said user browse the location-based content associated with anyone of said clustered map marker in said map marker cluster using said preview and full-view content-browsing windows.

6) The method of claim 1 further comprising:
a) said map-based user interface tagging pre-specified keywords to said map markers when said map markers are created on said map surface.
b) said map-based user interface providing means for letting said user execute a map-marker-search based on a keyword and said map-based user interface responding by showing on said map surface only the map markers with said tagged keyword.

7) The method of claim 6 further comprising:
a) said map-based user interface computing the keywords of said map markers' associated location-based content and associating them as derived keywords for said map markers.
b) said map-based user interface applying said derived keywords together with said tagged keywords of said map markers during said keyword search to generate said shown map markers on said map surface.

8) A method for editing content associated with a map marker displayed on a map surface comprising:
a) a map-based user interface providing means for letting a guest user login as a registered user to receive location-based content editing privileges.
b) said map-based user interface creating and positioning a map marker on a map surface of real-world geographical region where said map marker is associated with location-based content created by said logged-in user and relevant to said map marker's designated position on said map surface.
c) said map-based user interface providing means for letting said logged-in user apply an interactive gesture on said map marker to open a full-view content-editing window that is layered on-top of said map surface for editing said location-based content.
d) said map-based user interface providing means for letting said registered user save editing changes of said location-based content made through said full-view content-editing window.

9) The method of claim 8 further comprising:
a) said map-based user interface providing means for letting said logged-in user submit said saved location-based content to a location-based content administrator as a content-change request seeking approval for publication on said map surface.

10) The method of claim 8 further comprising:
a) said map-based user interface generating a transition effect between said map marker and said full-view content-editing window during the opening of said full-view content-editing window.

11) The method of claim 8 further comprising:
a) spatial gaps between the outer edges of said full-view content-editing window and the inner edges of said map-based user interface window such that said map surface under said full-view content-editing window can be partially visible.

12) The method of claim 8 further comprising:
a) said map-based user interface providing means for letting said logged-in user apply an interactive gesture on said map marker to open a small preview version of said content-editing window that is layered on-top of said map surface near said map marker for editing said location-based content.
b) said map-based user interface providing means for letting said logged-in user apply an interactive gesture on said preview version of said content-editing window to expand it into said full-view content-editing window.

13) The method of claim 8 further comprising:
a) said map-based user interface providing means for letting said registered user create a new map marker associated with location-based content at a designated location on said map surface.
b) said map-based user interface providing means for letting said registered user select a user-created map marker associated with location-based content on said map surface and adjust the designated location of said selected map marker.
c) said map-based user interface providing means for letting said registered user select a user-created map marker associated with location-based content on said map surface and delete said selected map marker.

14) The method of claim 8 further comprising:
a) said map-based user interface clustering said map markers located in close proximity to each other as a map marker cluster on said map surface.
b) said map-based user interface providing means for letting said registered user edit the location-based content associated with anyone of said clustered map marker in said map marker cluster using said full-view content-editing windows.

15) The method of claim 8 further comprising:
a) said map-based user interface providing means for letting said registered user specify a keyword and tag a selected map marker with said specified keyword.
b) said map-based user interface providing means for letting said registered user execute a map-marker search based on a keyword and said map-based user interface responding by showing on said map surface only the map markers with said tagged keyword.

16) The method of claim 15 further comprising:
a) said map-based user interface computing the keywords of said map markers' associated location-based content and associating them as derived keywords for said map markers.
b) said map-based user interface applying said derived keywords together with said tagged keywords of said map markers during said keyword search to generate said shown map markers on said map surface.

17) A method for providing a user interface for location-based content-change monitoring and administration comprising:
a) a map-based user interface creating and positioning map markers on a map surface of real-world geographical region where said map markers are associated with location-based contents created by many users and relevant to their respective map markers' positions of on said map surface.
b) said map-based user interface providing means for letting a user login as a location-based content administrator.
c) said map-based user interface providing a content-change alert by visually decorating a map marker if it is associated with a pending content-change request.
d) said map-based user interface providing means for letting said administrator apply an interactive gesture on said decorated map marker to open a content-browsing window to load and inspect the location-based content associated with said decorated map marker to perform content inspection for said pending content-change request.
e) said map-based user interface providing said administrator with means for approving and rejecting said pending content-change request associated with said inspected location-based content.

18) The method of claim 17 further comprising:
a) said map-based user interface clustering said map markers located in close proximity to each other as a map marker cluster on said map surface.
b) said map-based user interface providing means for letting said administrator browse the location-based content associated with anyone of said clustered map marker in said map marker cluster using said content-browsing window.

19) The method of claim 18 further comprising:
a) said map-based user interface providing a content-change alert by visually decorating said map marker cluster if anyone of its clustered map marker is associated with a pending content-change request.
b) said map-based user interface providing means for letting said administrator apply an interactive gesture on said decorated map marker cluster to open a content-browsing window to load and inspect the location-based content associated with said clustered map marker with said pending content-change request to perform content inspection for said pending content-change request.

20) The method of claim 17 further comprising:
a) said map-based user interface providing means for letting said administrator apply an interactive gesture on a non-decorated map marker to open said content-browsing window to inspect its associated location-based content.
b) said map-based user interface providing said administrator with means for un-publishing said inspected location-based content associated with said non-decorated map marker.
